(19) United States
(12) Patent Application Publication
(10) Pub. No.: US 2026/0225438 A1
(43) Pub. Date: Aug. 6, 2026

(54) ELECTRIC DRIVE AXLE WITH HEAT SHIELD

(71) Applicant: FCA US LLC, Auburn Hills, MI (US)

(72) Inventors: Michael L Nemeth, Auburn Hills, MI (US); Christopher Gomez, Auburn Hills, MI (US); Andrew R Seurynck, Auburn Hills, MI (US)

(21) Appl. No.: 19/042,135

(22) Filed: Jan. 31, 2025

(51) Int. Cl. B60K 6/405

(52) U.S. Cl. CPC B60K 6/405

(57) ABSTRACT

An integrated heat shield and oil deflector for an electric drive unit of an electrified vehicle includes a lower end configured to couple to a skid plate disposed beneath the electric drive unit, an opposite upper end disposed below the engine, and a main body extending between the upper end and the lower end. An oil deflector is formed in the main body and configured to be disposed beneath the engine. The oil deflector is configured to catch oil falling from the engine and direct the oil away from the electric drive unit and the skid plate. The integrated heat shield and oil deflector is configured to be disposed between the electric drive unit and an engine exhaust system to facilitate preventing heat generated by the exhaust system from affecting sensitive electrical components of the electric drive unit.

### FIELD

The present application generally relates to electrified vehicles and, more particularly, to an electric drive axle module with a multi-purpose heat shield.

### BACKGROUND

A hybrid electric vehicle includes at least one battery system associated with an internal combustion engine system and at least one electric drive unit, such as an electric drive module (EDM) or electric drive axle (e-axle). The electric drive unit includes at least one electric motor and associated electric drive gearbox assembly. Typically, the electrified vehicle includes a high voltage battery system and a low voltage (e.g., 12 volt) battery system. In such a configuration, the high voltage battery system is utilized to power the electric motor(s) and to recharge the low voltage battery system via a direct current to direct current (DC-DC) convertor. However, in some packaging scenarios, the internal combustion engine system may generate temperatures that are too hot for sensitive components of the electronic drive unit. Accordingly, while such electronic drive modules do work well for their intended purpose, there is a desire for improvement in the relevant art.

### SUMMARY

According to one example aspect of the invention, an integrated heat shield and oil deflector for an electric drive unit of an electrified vehicle having an internal combustion engine disposed above the electric drive unit is provided. In one example configuration, the integrated heat shield and oil deflector includes a lower end configured to couple to a skid plate disposed beneath the electric drive unit, an opposite upper end disposed below the engine, and a main body extending between the upper end and the lower end. An oil deflector is formed in the main body and configured to be disposed beneath the engine. The oil deflector is configured to catch oil falling from the engine and direct the oil away from the electric drive unit and the skid plate. The integrated heat shield and oil deflector is configured to be disposed between the electric drive unit and an exhaust system of the engine to facilitate preventing heat generated by the exhaust system from affecting sensitive electrical components of the electric drive unit.

In addition to the foregoing, the described integrated heat shield and oil deflector may include one or more of the following features: wherein the oil deflector includes a ramp oriented at an angle to facilitate directing oil away from the electric drive unit and the skid plate; wherein the oil deflector includes a trough configured to catch the oil and direct the oil toward a top of the ramp; an attachment flange extending outwardly from the trough, wherein the attachment flange is configured to couple to the electric drive unit; and wherein the lower end includes a plurality of apertures each configured to receive a fastener for coupling the lower end to the skid plate.

In addition to the foregoing, the described integrated heat shield and oil deflector may include one or more of the following features: a J-nut for each fastener for securing the integrated heat shield and oil deflector to the skid plate; wherein the oil deflector is configured to be disposed beneath a drain plug and an oil filter of the engine; wherein the main body includes a plurality of integrally formed ribs configured to provide structural rigidity to the integrated heat shield and oil deflector; and wherein the upper end wraps around and over a portion of the electric drive unit, wherein the upper end includes a first section coupled to the main body and extending outwardly therefrom at an angle relative thereto, and a second section coupled to the first section and extending outwardly therefrom generally perpendicular to the main body to thereby cover an upper portion of the electric drive unit.

According to another example aspect of the invention, an electrified vehicle is provided. In one example configuration, the electrified vehicle includes an electric drive unit configured to generate and transfer drive torque to a driveline, a skid plate coupled to a bottom of the electrified drive unit, an internal combustion engine disposed above the electrified drive unit, an exhaust system coupled to the internal combustion engine and disposed proximate the electrified drive unit, and an integrated heat shield and oil deflector disposed between the electric drive unit and at least a portion of the exhaust system.

The integrated heat shield and oil deflector includes a lower end configured to couple to the skid plate, an opposite upper end disposed below the engine, a main body extending between the upper end and the lower end, and an oil deflector formed in the main body and configured to be disposed beneath the engine. The oil deflector is configured to catch oil falling from the engine and direct the oil away from the electric drive unit and the skid plate. The integrated heat shield and oil deflector is disposed between the electric drive unit and the exhaust system to facilitate preventing heat generated by the exhaust system from affecting sensitive electrical components of the electric drive unit.

In addition to the foregoing, the described electrified vehicle may include one or more of the following features: wherein the engine includes an oil filter and an oil sump with a drain plug, and wherein the oil deflector is disposed beneath the oil filter and the drain plug to catch oil falling therefrom; wherein the oil deflector includes a ramp oriented at an angle to facilitate directing oil away from the electric drive unit and the skid plate; wherein the oil deflector includes a trough configured to catch the oil and direct the oil toward a top of the ramp; an attachment flange extending outwardly from the trough, wherein the attachment flange is coupled to the electric drive unit; wherein the lower end includes a plurality of apertures each configured to receive a fastener for coupling the lower end to the skid plate; and a J-nut for each fastener for securing the integrated heat shield and oil deflector to the skid plate.

In addition to the foregoing, the described electrified vehicle may include one or more of the following features: wherein the main body includes a plurality of integrally formed ribs configured to provide structural rigidity to the integrated heat shield and oil deflector; wherein the sensitive electrical components include a power inverter module (PIM) and high voltage (HV) cables connected thereto, wherein the integrated heat shield is disposed directly adjacent to the PIM and the HV cables; wherein the upper end wraps around and over the PIM and the HV cables, wherein the upper end includes a first section coupled to the main body and extending outwardly therefrom at an angle relative thereto, and a second section coupled to the first section and extending outwardly therefrom generally perpendicular to the main body to thereby cover an upper portion of the electric drive unit; and wherein the electric drive unit is an electric drive axle configured to direct drive one or more axles of the electrified vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an electric drive unit in accordance with the principles of the present disclosure;

FIG. 2 is a perspective view of an example powertrain with an internal combustion engine, electric drive unit, and heat shield disposed therebetween, in accordance with the principles of the present disclosure; and

FIG. 3 is a rear perspective view of the heat shield shown in FIG. 2, in accordance with the principles of the present disclosure.

### DESCRIPTION

As discussed above, a hybrid electric vehicle typically includes an electrified powertrain having at least one electric drive unit and an internal combustion engine system associated with a high voltage (HV) battery system. In some packaging scenarios, portions of the internal combustion engine system (e.g., exhaust system, catalytic converters, etc.) may be located in close proximity to the electric drive unit, such as an electric drive module (EDM) or electric drive axle (e-axle). However, heat from the engine system may adversely affect sensitive components of the electric drive unit such as, for example, a power inverter module (PIM), HV wiring, low voltage (LV) wiring, cooling lines, etc. Moreover, the engine system may be located above the electric drive unit, and engine oil may fall on the sensitive components, for example, during an oil change.

Accordingly, described herein are systems and methods to protect an electric drive unit from high temperatures and oil from an internal combustion engine system packaged in close proximity to the electric drive unit. In one example, a heat shield with an integrated oil trough/deflector is configured to protect the electric drive unit components from heat and catch/deflect any engine oil from servicing the oil drain plug or oil filter. In this way, the heat shield blocks heat from the engine system and prevents engine oil from falling on the electric drive unit components, thereby keeping them clean from any oil spillage. Moreover, the integrated heat shield and oil deflector enable a compact packaging arrangement with reduced parts while allowing for full jounce movements of the electric drive unit.

The system describe herein advantageously includes only a single heat shield, which can be coupled to a drive unit skid plate to improve plant assembly time. By combining the heat shield with the oil deflection trough, the entire part is more compact and can better fit the tight clearance needed for e-axle full jounce to the engine. In one example, four ‘J’ nuts are utilized to attach the heat shield through holes in the skid plate, making manufacturing of the skid plate easier and eliminating a more expensive and complicated weld nut procedure. As such, the heat shield and oil deflector may be both easily assembled to the skid plate and easily removed for electric drive unit maintenance.

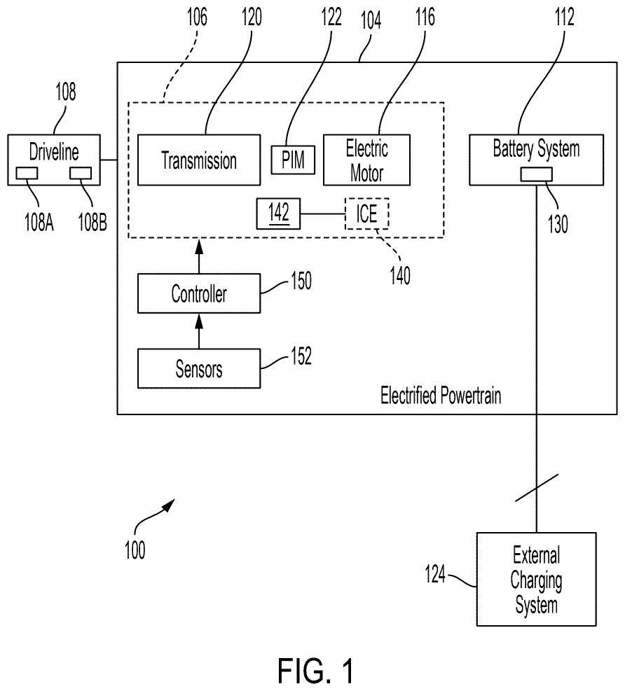

Referring now to FIG. 1, a functional block diagram of an example hybrid electric vehicle 100 (also referred to herein as “vehicle 100”) according to the principles of the present application is illustrated. The vehicle 100 includes an electrified powertrain 104 having an electric drive unit 106 configured to generate and transfer drive torque to a driveline 108 having drive axles 108A, 108B for vehicle propulsion. The electric drive unit 106 is powered by electrical energy provided from one or more battery systems 112 (e.g., high voltage battery pack(s)). In one example, the electric drive unit 106 is an e-axle configured to directly drive front axle(s) 108A or rear axle(s) 108B. In another example, the electric drive unit 106 is an EDM. The electric drive unit 106 generally includes an electric motor 116 (e.g., electric traction motor), an electric drive gearbox assembly or transmission 120, and power electronics including a power inverter module (PIM) 122.

The electric motor 116 is selectively connectable via the PIM 122 to the high voltage (HV) battery system 112 for powering the electric motor 116. The battery system 112 is selectively connectable (e.g., by the driver) to an external charging system 124 (also referred to herein as “charger 124”) for charging of the battery system 112. The battery system 112 includes at least one HV battery pack assembly 130. In the example embodiment, the electrified powertrain 104 is a hybrid powertrain that additionally includes an internal combustion engine 140. A controller 150 can provide various inputs to the electric drive unit 106, based on signals received from sensors 152 to operate the electric drive unit 106 in various modes based on various operating conditions.

The engine 140 receives fuel (e.g., gasoline) from a fuel tank (not shown) and combusts a mixture of air and fuel within cylinders to drive pistons and generate torque. The generated torque drives a motor/generator 142 to produce electricity to charge the HV battery 130 or power the electric drive unit 106 directly. In other operations, the motor/generator 142 is powered by the HV battery 130 to control engine stop/start operations. The electric drive unit 106 is powered by the HV battery 130 and/or the motor/generator 142 to selectively and respectively provide drive torque to the front axle 108a and/or rear axle 108b. The vehicle 100 includes a low voltage battery system (not shown) configured to support various low voltage (e.g., 12V) loads of the vehicle 100, for example, to power various electrical components. The HV battery system 112 is configured to power high voltage loads such as the electric drive unit 106.

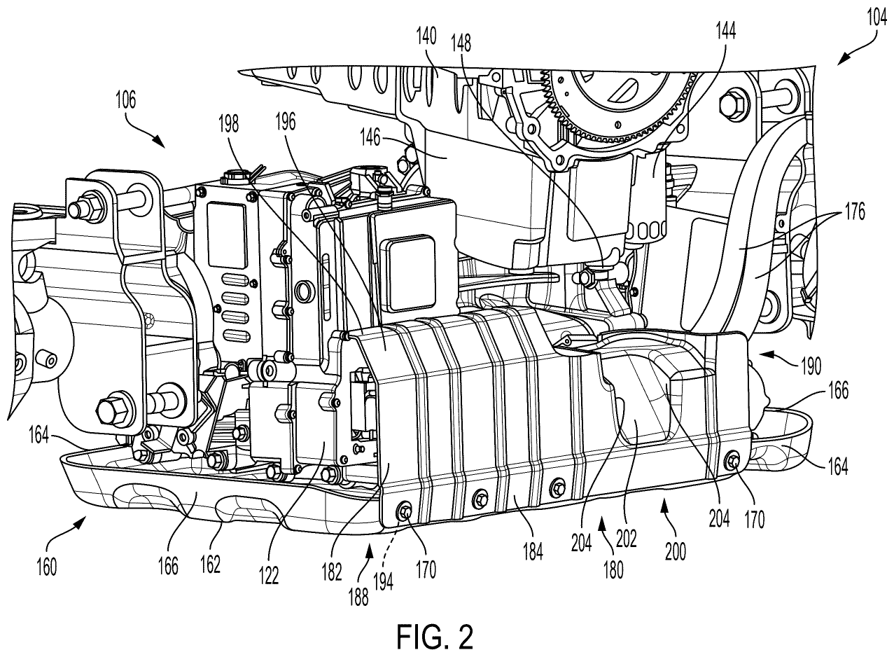

With reference now to FIG. 2, one example packaging arrangement of the electric drive unit 106 and engine 140 is shown according to the principles of the present application. As described herein in more detail, a skid plate 160 is coupled to the electric drive unit 106, and a combined/integrated heat shield and oil deflector 180 is coupled to the skid plate 160. In the example embodiment, the engine 140 is generally located above the electric drive unit 106 and includes an oil filter 144 and an oil sump 146 with a drain plug 148. The skid plate 160 is coupled to a bottom of the electric drive unit 106 and generally includes a bottom wall 162 with a first pair of opposed walls 164 and a second pair of opposed walls 166 extending upwardly therefrom.

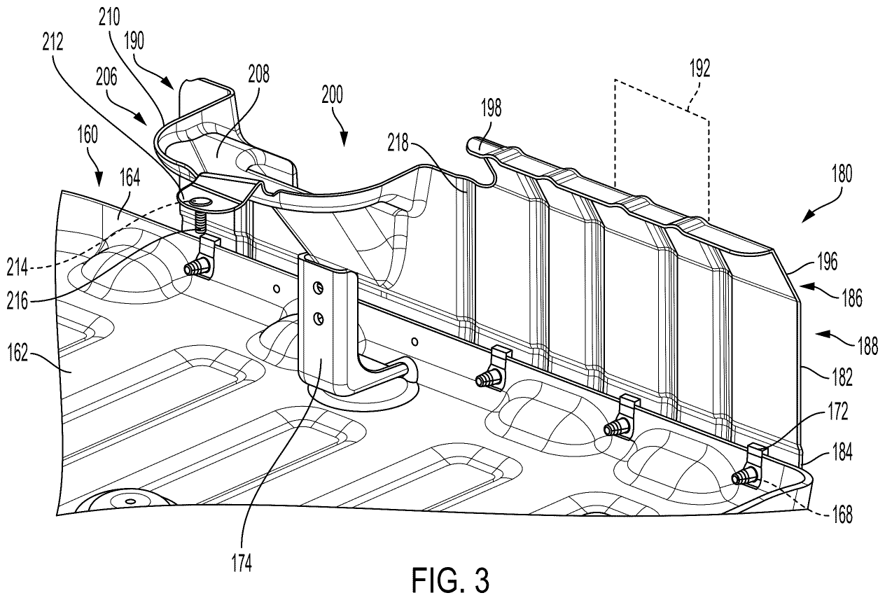

With additional reference to FIG. 3, one skid plate wall 164 includes a plurality of apertures 168 each configured to receive a fastener 170 (e.g., bolt) for coupling the integrated heat shield and oil deflector 180 thereto. In the example embodiment, each fastener 170 is coupled to a nut 172 (e.g., “J” nut) for further securing the integrated heat shield and oil deflector 180 to the skid plate 160. Moreover, in one example (shown), the system advantageously only requires four fasteners 170 for coupling the integrated heat shield and oil deflector 180 to the skid plate. Additionally, as shown in FIG. 3, an L-shaped bracket 174 is coupled to the skid plate bottom wall 162. The bracket 174 is configured to support and secure to HV cables 176 that are configured to plug into the PIM 122.

With continued reference to FIGS. 2 and 3, the integrated heat shield and oil deflector 180 will be described in more detail. In the example embodiment, the heat shield/deflector 180 is configured to shield the electric drive unit 106 from heat radiating components of the engine 140 (e.g., exhaust pipes, catalysts, etc.). The heat shield/deflector 180 is also configured to direct oil originating from the engine 140 (e.g., oil filter 144, drain plug 148, etc.) away from the electric drive unit 106 and skid plate 160. The heat shield/deflector 180 may be fabricated from a generally rigid material such as, for example, metal, plastic, glass filled nylon, etc. In one example, the heat shield/deflector 180 is single component stamped from a single piece of sheet metal.

In the example embodiment, the heat shield/deflector 180 is generally sheet-like or plate-like and includes a main body 182 disposed between a first or lower end 184 and an opposite second or upper end 186. The heat shield/deflector 180 also extends from a first side 188 to an opposite second side 190. The main body 182 is generally planar and configured to separate the electric drive unit 106 and at least a portion of an exhaust system 192 of the engine 140. Although shown schematically, the exhaust system 192 may include one or more exhaust pipes/conduits and/or one or more catalytic converters.

The lower end 184 includes a plurality of apertures 194 configured to receive fasteners 170 therethrough. The lower end 184 is disposed against skid plate wall 164 in alignment with the plurality of apertures 168 thereof. In this way, the aligned apertures 168, 194 are each configured to receive fastener 170 for coupling the heat shield/deflector 180 to the skid plate 160. The upper end 186 is angled away from the main body 182 and is configured to wrap around and over one or more portions of the electric drive unit 106. In the example embodiment, the upper end 186 wraps around and over the PIM 122 and HV cables 176 to shield an upper end thereof from heat generated by the engine 140 and exhaust system 192. In the example embodiment, the upper end 186 includes a first section 196 disposed at an angle (e.g., 45°) between the main body 182 and a second section 198. In one example, the second section 198 is disposed perpendicular to or substantially perpendicular to the main body 182.

As shown in FIGS. 2 and 3, the main body 182 includes an integrated oil deflector 200 configured to be disposed beneath the engine 140, and in particular, the oil filter 144 and drain plug 148. In this way, any oil falling from the oil filter 144 and drain plug 148 are deflected away from the electric drive unit 106 and skid plate 160. In the example embodiment, the oil deflector 200 includes a chute or ramp 202 disposed between opposed sidewalls 204. The ramp 202 is oriented at an angle (e.g., 45°) relative to the main body 182. The ramp 202 is disposed beneath the oil filter 144 and drain plug 148 and oriented at a downward angle to catch and direct oil away from the PIM 122 and skid plate 160. As shown in FIG. 3, a catch basin or trough 206 is formed at an upper end of the ramp 202 and includes a catch surface 208 with a raised flange 210 on the perimeter thereof. The trough 206 is configured to catch oil and direct it towards the ramp 202.

In the example embodiment, an attachment flange 212 extends outwardly from the trough 206 and includes an aperture 214 configured to receive a fastener 216 for coupling the attachment flange 212 to a portion of the electric drive unit 106. Additionally, in some examples, the heat shield/deflector 180 may include a plurality of vertically arranged ribs 218 extending from the first end 184 to the second end 186. The ribs 218 are integrally formed with (e.g., stamped into) the heat shield/deflector 180 and configured to provide structural rigidity thereto.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An integrated heat shield and oil deflector for an electric drive unit of an electrified vehicle having an internal combustion engine disposed above the electric drive unit, the integrated heat shield and oil deflector comprising:
a lower end configured to couple to a skid plate disposed beneath the electric drive unit;
an opposite upper end disposed below the engine;
a main body extending between the upper end and the lower end; and
an oil deflector formed in the main body and configured to be disposed beneath the engine, the oil deflector configured to catch oil falling from the engine and direct the oil away from the electric drive unit and the skid plate,
wherein the integrated heat shield and oil deflector is configured to be disposed between the electric drive unit and an exhaust system of the engine to facilitate preventing heat generated by the exhaust system from affecting sensitive electrical components of the electric drive unit.

2. The integrated heat shield and oil deflector of claim 1, wherein the oil deflector includes a ramp oriented at an angle to facilitate directing oil away from the electric drive unit and the skid plate.

3. The integrated heat shield and oil deflector of claim 2, wherein the oil deflector includes a trough configured to catch the oil and direct the oil toward a top of the ramp.

4. The integrated heat shield and oil deflector of claim 3, further comprising an attachment flange extending outwardly from the trough, wherein the attachment flange is configured to couple to the electric drive unit.

5. The integrated heat shield and oil deflector of claim 1, wherein the lower end includes a plurality of apertures each configured to receive a fastener for coupling the lower end to the skid plate.

6. The integrated heat shield and oil deflector of claim 5, further comprising a J-nut for each fastener for securing the integrated heat shield and oil deflector to the skid plate.

7. The integrated heat shield and oil deflector of claim 1, wherein the oil deflector is configured to be disposed beneath a drain plug and an oil filter of the engine.

8. The integrated heat shield and oil deflector of claim 1, wherein the main body includes a plurality of integrally formed ribs configured to provide structural rigidity to the integrated heat shield and oil deflector.

9. The integrated heat shield and oil deflector of claim 1, wherein the upper end wraps around and over a portion of the electric drive unit, wherein the upper end includes:
a first section coupled to the main body and extending outwardly therefrom at an angle relative thereto; and
a second section coupled to the first section and extending outwardly therefrom generally perpendicular to the main body to thereby cover an upper portion of the electric drive unit.

10. An electrified vehicle, comprising:
an electric drive unit configured to generate and transfer drive torque to a driveline;
a skid plate coupled to a bottom of the electrified drive unit;
an internal combustion engine disposed above the electrified drive unit;
an exhaust system coupled to the internal combustion engine and disposed proximate the electrified drive unit; and
an integrated heat shield and oil deflector disposed between the electric drive unit and at least a portion of the exhaust system, the integrated heat shield and oil deflector comprising:
a lower end configured to couple to the skid plate;
an opposite upper end disposed below the engine;
a main body extending between the upper end and the lower end; and
an oil deflector formed in the main body and configured to be disposed beneath the engine, the oil deflector configured to catch oil falling from the engine and direct the oil away from the electric drive unit and the skid plate,
wherein the integrated heat shield and oil deflector is disposed between the electric drive unit and the exhaust system to facilitate preventing heat generated by the exhaust system from affecting sensitive electrical components of the electric drive unit.

11. The electrified vehicle of claim 10, wherein the engine includes an oil filter and an oil sump with a drain plug,
wherein the oil deflector is disposed beneath the oil filter and the drain plug to catch oil falling therefrom.

12. The electrified vehicle of claim 10, wherein the oil deflector includes a ramp oriented at an angle to facilitate directing oil away from the electric drive unit and the skid plate.

13. The electrified vehicle of claim 12, wherein the oil deflector includes a trough configured to catch the oil and direct the oil toward a top of the ramp.

14. The electrified vehicle of claim 13, further comprising an attachment flange extending outwardly from the trough, wherein the attachment flange is coupled to the electric drive unit.

15. The electrified vehicle of claim 10, wherein the lower end includes a plurality of apertures each configured to receive a fastener for coupling the lower end to the skid plate.

16. The electrified vehicle of claim 15, further comprising a J-nut for each fastener for securing the integrated heat shield and oil deflector to the skid plate.

17. The electrified vehicle of claim 10, wherein the main body includes a plurality of integrally formed ribs configured to provide structural rigidity to the integrated heat shield and oil deflector.

18. The electrified vehicle of claim 10, wherein the sensitive electrical components include a power inverter module (PIM) and high voltage (HV) cables connected thereto,
wherein the integrated heat shield is disposed directly adjacent to the PIM and the HV cables.

19. The electrified vehicle of claim 18, wherein the upper end wraps around and over the PIM and the HV cables, wherein the upper end includes:
a first section coupled to the main body and extending outwardly therefrom at an angle relative thereto; and
a second section coupled to the first section and extending outwardly therefrom generally perpendicular to the main body to thereby cover an upper portion of the electric drive unit.

20. The electrified vehicle of claim 10, wherein the electric drive unit is an electric drive axle configured to direct drive one or more axles of the electrified vehicle.
